(19) United States
(12) Patent Application Publication
(10) Pub. No.: US 2014/0262388 A1
(43) Pub. Date: Sep. 18, 2014

(54) TOOL HAVING A REAR MOTOR

(71) Applicant: Milwaukee Electric Tool Corporation, Brookfield, WI (US)

(72) Inventors: Sven A. Krause, Middleton, WI (US); Jeffrey M. Zeiler, Pewaukee, WI (US)

(21) Appl. No.: 14/206,391

(22) Filed: Mar. 12, 2014

Related U.S. Application Data
(60) Provisional application No. 61/798,102, filed on Mar. 15, 2013.

(51) Int. Cl. B23Q 5/10; A01D 34/90; B25F 5/00; A01G 3/053

(52) U.S. Cl. CPC B23Q 5/10; A01G 3/053; A01D 34/90; B25F 5/001
USPC 173/1; 173/216

(57) ABSTRACT

A tool including a first portion housing, a second portion housing, and a driveshaft housing. The first portion housing includes a motor, configured to provide a top rotational movement at a first angular speed, and a controller. The controller operates the motor at a second angular speed. The second portion housing includes a gear box and a tool head. The driveshaft housing, including a driveshaft, connects the first portion housing to the second portion housing. The driveshaft transmits the rotational movement at the second angular speed from the first portion housing to the second portion housing. The gear box receives the rotational movement at the second angular speed and outputs the rotational movement at a third angular speed. The tool head receives the rotational movement at the third angular speed from the gearbox.

### RELATED APPLICATION

The present application claims priority to U.S. Provisional Application 61/798,102, filed Mar. 15, 2013, the entire contents of which are hereby incorporated.

### BACKGROUND

The present invention generally relates to power tools, specifically lawn and garden power tools, such as string trimmers, hedge-trimmers, leaf-blowers, etc.

Traditionally lawn and garden power tools are powered by a gasoline engine located at the rear of the unit. Lawn and garden power tools can also be electrically-powered, either by 120-volt AC power source or a DC battery power source.

### SUMMARY

In one embodiment, the invention provides a tool having a first portion housing, a second portion housing, and a driveshaft housing. The first portion housing includes a motor configured to provide a top rotational movement at a first angular speed, a battery receptacle configured to receive a battery, the battery configured to power the motor, a user-switch, and a controller. The controller is configured to receive a user input from the user-switch, and operate the motor at a second angular speed upon receiving the user input. The second portion housing includes a gear box and a tool head. The driveshaft housing, including a driveshaft, connects the first portion housing to the second portion housing. The driveshaft transmits the rotational movement at the second angular speed from the first portion housing to the second portion housing. The gear box receives the rotational movement at the second angular speed and outputs the rotational movement at a third angular speed. The tool head receives the rotational movement at the third angular speed from the gearbox.

In another embodiment the invention provides a method of transmitting rotational movement in a tool. The tool includes a first portion housing, a second portion housing, and a driveshaft housing. The first portion housing includes a motor and a user-switch. The motor provides a top rotational movement at a first angular speed. The second portion housing includes a gear box and a tool head. The driveshaft housing, including a driveshaft, connects the first portion housing to the second portion housing. The method includes receiving a user input from the user-switch; operating the motor at a second angular speed upon receiving the user input; transmitting, via the driveshaft, the rotational movement at the second angular speed from the first portion housing to the second portion housing; receiving the rotational movement into the gearbox at the second angular speed; outputting the rotational movement from the gearbox at a third angular speed; and receiving the rotational movement into the tool head at the third angular speed.

Other aspects of the invention will become apparent by consideration of the detailed description and accompanying drawings.

### BRIEF DESCRIPTION OF THE DRAWINGS

FIG. 1 illustrates a block diagram of a power tool according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIG. 1 is a block diagram illustrating a power tool 10. The power tool 10 includes an upper or first portion housing 15 and a bottom or second portion housing 20. A driveshaft housing 25 connects the first portion housing 15 to the second portion housing 20 of the power tool 10. The driveshaft housing 25 contains a driveshaft 27 and a driveshaft handle 29. The driveshaft 27 transmits torque and rotation from the first portion housing 15 to the second portion housing 20. The driveshaft handle 29 allows a user to hold the driveshaft housing 25. In one embodiment the driveshaft handle 29 is a pull handle (e.g., a U-shaped handle). In another embodiment the driveshaft handle 29 is a grip handle (e.g., a stem-handle seen on a power tool, such as a power drill).

The first portion housing 15 includes a user-handle 30, a battery 32, a motor 34, a controller 36, and a user-switch 38. The user-handle 30 allows a user to hold the tool 10 by the first portion housing 15. In one embodiment the user-handle 30 is a pull handle. In another embodiment the user-handle 30 is a grip handle. In one embodiment the user-switch 38 is located on, or part of, the user-handle 30.

In one embodiment, the battery 32 is a rechargeable lithium-ion battery. Alternatively, the battery 32 may include chemistries other than lithium-ion such as, for example, nickel cadmium, nickel metal-hydride, or the like. Additionally or alternatively, the battery 32 may be a non-rechargeable battery. In another embodiment, rather than a battery 32, the motor 34 is powered by an AC power source. In one embodiment, the battery 32 is a power tool battery pack, including a latching mechanism for selectively securing the battery 32 to the power tool 10, and a pack housing containing battery cells within the pack housing.

In one embodiment, the motor 34 is a direct-current blushless electric motor. Alternatively, the motor 34 may be another motor type, such as an alternating-current electric motor or a direct-current brushed electric motor. The motor 34 is controlled by the controller 36. The controller 36 controls the angular speed of the motor 34, for example, by clipping the top angular speed of the motor 34 to a predetermined operating angular speed. The controller 36 further receives a signal from the user-switch 38 and activates or deactivates the motor 34 according to the activation or deactivation of the user-switch 38.

The second portion housing 20 includes a gear box 40 and a tool head 45. The gear box 40 includes gears at a fixed ratio, called a fixed gear ratio. The fixed gear ratio is predetermined to take the angular speed of the driveshaft 27, which is inputted into the gear box 40, and outputs a slower angular speed to the tool head 45. In one embodiment, the gear box 40 has a fixed gear ratio of 1.42:1.

The tool head 45 varies depending on the functionality of the power tool 10. In one embodiment the tool head 45 is a string-trimmer head used for trimming grass or other plant objects. In another embodiment the tool head 45 is a chainsaw blade used for cutting trees and larger plant objects. In other embodiments, the tool head 45 is one of a fan used for a leaf blower or a hedge trimmer head used for trimming bushes or other plant objects. In one embodiment of the power tool 10, the tool head 45 is interchangeable such that the various head types may be selectively attached.

In operation a user activates the user-switch 38. The controller 36 receives a signal from the user-switch 38. Upon receiving the signal from the user-switch 38 the controller 36 activates the motor 34, which receives power from the battery 32. For instance, the controller 36 controls switching elements (e.g., MOSFETs) to selectively supply power from the battery 32 to terminals of the motor 34 to drive the motor 34. In one embodiment, the motor 34 has a top angular speed of approximately 13,000 RPMs. The controller 36 can clip, or limit, the angular speed of the motor 34 to a first predetermined angular speed. The first predetermined angular speed for example may be approximately 10,000 RPMs. Clipping the angular speed of the motor 34 results in the motor 34 spinning the driveshaft 27 at a lower angular speed while maintaining the torque necessary to operate the power tool 10. The spinning driveshaft 27 is coupled to the gear box 40, which further reduces the angular speed to a second predetermined angular speed, which is lower than the first predetermined angular speed, for spinning the tool head 45. The second predetermined angular speed for example may be approximately 7,000 RPMs. In other embodiments, the angular speed of the motor 34, the first predetermined angular speed, and/or the second predetermined angular speed are increased or decreased.

Having the battery 32 and motor 34 in the first portion housing 15, while the gear box 40 and tool head 45 are in the second portion housing 20, results in a weight distribution which is similar to a traditional gasoline-engine powered tool. Further, by placing the battery 32 and motor 34 in the first portion housing 15, the battery 32 and motor 34 are less prone to damage and less vulnerable to debris. Further, by placing the battery 32 and motor 34 in the first portion housing 15, the look and feel of a traditional gasoline engine powered power tool is replicated.

Thus, the invention provides, among other things, a battery-powered lawn and garden tool. Various features and advantages of the invention are set forth in the following claims.

What is claimed is:

1. A tool comprising:
a first portion housing including
a motor configured to provide a top rotational movement at a first angular speed,
a battery receptacle configured to receive a battery, the battery configured to power the motor,
a user-switch, and
a controller configured to
receive a user input from the user-switch, and
operate the motor at a second angular speed upon receiving the user input;
a second portion housing including a gear box and a tool head; and
a driveshaft housing including a driveshaft, the driveshaft housing connecting the first portion housing to the second portion housing;
wherein, the driveshaft transmits the rotational movement at the second angular speed from the first portion housing to the second portion housing; and
wherein, the gear box receives the rotational movement at the second angular speed and outputs the rotational movement at a third angular speed, the tool head receiving the rotational movement at the third angular speed from the gearbox.

2. The tool of claim 1, wherein the controller operates the motor at the second angular speed by clipping the first angular speed.

3. The tool of claim 1, wherein the gear box has a fixed gear ratio of approximately 1.42:1.

4. The tool of claim 1, wherein the first angular speed is approximately 13,000 RPMs.

5. The tool of claim 1, wherein the second angular speed is approximately 10,000 RPMs.

6. The tool of claim 1, wherein the third angular speed is approximately 7,000 RPMs.

7. The tool of claim 1, wherein the tool head is one of a string-trimmer head, a chainsaw blade, a leaf-blower fan, or a hedge-trimmer head.

8. The tool of claim 1, wherein the motor is a direct-current motor.

9. The tool of claim 1, wherein the first portion housing further includes a user-handle.

10. The tool of claim 1, wherein the driveshaft housing further includes a driveshaft handle.

11. A method of transmitting rotational movement in a tool, the tool including a first portion housing including a motor and a user-switch, the motor providing a top rotational movement at a first angular speed, a second portion housing including a gear box and a tool head, and a driveshaft housing including a driveshaft, the driveshaft housing connecting the first portion housing to the second portion housing, the method comprising:
receiving a user input from the user-switch;
operating the motor at a second angular speed upon receiving the user input;
transmitting, via the driveshaft, the rotational movement at the second angular speed from the first portion housing to the second portion housing;
receiving the rotational movement into the gearbox at the second angular speed;
outputting the rotational movement from the gearbox at a third angular speed; and
receiving the rotational movement into the tool head at the third angular speed.

12. The method of claim 11, wherein the top rotational movement at the first angular speed is clipped in order to operate the motor at the second angular speed.

13. The method of claim 11, wherein the gear box has a fixed gear ratio of approximately 1.42:1.

14. The method of claim 11, wherein the first angular speed is approximately 13,000 revolutions per minute.

15. The method of claim 11, wherein the second angular speed is approximately 10,000 revolutions per minute.

16. The method of claim 11, wherein the third angular speed is approximately 7,000 revolutions per minute.

17. The method of claim 11, wherein the tool head is one of a string-trimmer head, a chainsaw blade, a leaf-blower fan, or a hedge-trimmer head.

18. The method of claim 11, wherein the first portion housing further includes a battery receptacle configured to receive a battery.

19. The method of claim 18, wherein the battery provides power to the motor.

20. The method of claim 11, wherein the user-switch is located on a user-handle.
